(19) United States
(12) Patent Application Publication
(10) Pub. No.: US 2017/0154073 A1
(43) Pub. Date: Jun. 1, 2017

(54) SYSTEM AND METHOD FOR RETRIEVING DATA

(71) Applicant: Maluuba Inc., Waterloo (CA)

(72) Inventors: Zhiyuan WU, Waterloo (CA); Mahmoud ADADA, Kitchener (CA); Petar COTA, Kitchener (CA)

(21) Appl. No.: 15/319,751

(22) PCT Filed: Jun. 16, 2015
(86) PCT No.: PCT/CA2015/000392

§ 371 Date: Dec. 16, 2016

Related U.S. Application Data
(60) Provisional application No. 62/013,255, filed on Jun. 17, 2014.

(51) Int. Cl. G06F 17/30

(52) U.S. Cl. CPC G06F 17/30395; G06F 17/3048

(57) ABSTRACT

A system, method, and non-transitory computer readable medium for retrieving data in response to an input query is provided. The system includes a first data server configured to generate a query based on the input query and a second data server configured to generate a another query based on the input query. The system also includes a master server in communication with the data servers. The method involves generating queries based on the input query and sending the queries to data sources. The method also involves determining if data records represent the same external entity and combining data records to store. The non-transitory computer readable medium is encoded with codes to direct a processor to carry out the method.

### CROSS-REFERENCE TO RELATED APPLICATION

This application claims priority to of U.S. Patent Application No. 62/013,255 filed Jun. 17, 2014, the contents of which are incorporated herein by reference.

### FIELD

The present specification relates methods and systems for retrieving data, and more particularly to methods and systems for retrieving data from a plurality of data sources.

### BACKGROUND

Various methods and systems have been developed over time for retrieving data over a network connection. For example, search engines are commonly used in association with the Internet to retrieve a list of websites corresponding to a provided search query. As more data becomes publically available over the Internet, data providers have developed and maintained databases to provide information that is readily searchable. For example, various data sources can provide a directory of businesses indexed for fast searching by location, type of business, or other characteristics of the business. With the increase in popularity of the Internet, more businesses are looking to increase their presence on the Internet. For example, businesses now routinely create websites from which potential customers can obtain information such as a catalog of products and services, store locations, as well as contact information. Businesses also provide some of this information to third parties specializing in maintaining a database of businesses. Some databases can be a general directory such as what would be expected in a phone directory. Other databases specializing in particular types of businesses, such as restaurants or clothing stores, can also be used by businesses that want to direct their information to a targeted audience. In addition, there are also databases which collect information from customers who can post reviews about their experiences as well as other information about a business.

Since some databases may not store the same amount of information relating to a particular query, it is often necessary to search multiple databases manually to retrieve sufficient information. Furthermore, a database may experience technical difficulties that can either slow down the search speed to unacceptable speeds or the database may be unavailable or may not have the information requested. In addition, each database is generally accessed using a proprietary application programming interface (API) and returns results in a proprietary format.

### SUMMARY

In accordance with an aspect of the specification, there is provided a system for retrieving data in response to an input query. The system includes a first data server configured to generate a first query based on the input query. The first data server is further configured to send the first query to a first data source and to receive a first data record from the first data source. The system also includes a second data server configured to generate a second query based on the input query. The second data server is further configured to send the second query to a second data source and to receive a second data record from the second data source. In addition, the system includes a master server in communication with the first data server and the second data server. The master server is configured to determine whether the first data record and the second data record represent a single external entity. The master server is configured to combine the first data record and the second data record when the first data record and the second data record represent the same external entity to generate a master data record associated with the external entity. The master server is also configured to store the master data record in a memory storage unit.

The first data server and the second data server may be configured to operate in parallel.

The first data source may be associated with a first service provider and the second data source may be associated with a second service provider. The first service provider may be different from the second service provider.

The first data server may be configured to generate the first query in a first query format compatible with the first service provider and the second data server may be configured to generate the second query in a second query format compatible with the second service provider.

The first data server may be configured to receive the first data record in a first result format from the first data provider and the second data server may be configured to receive the second data record in a second result format from the second data source.

The first data server may be configured to translate the first result format into a standard result format. The second data server may be configured to translate the second result format into the standard result format.

The first data server may be configured to receive a first plurality of data records including the first data record from the first data source. The second data server may be configured to receive a second plurality of data records including the second data record from the second data source.

The master server may be configured to identify the first data record from the first plurality of data records and to identify the second data record from the second plurality of data records.

The first data record and the second data record may each include overlapping information associated the single external entity.

The first data record and the second data record may each include complimentary information associated the single external entity.

The master server may be configured to cache the master data record for subsequent use.

In accordance with another aspect of the specification, there is provided a method of retrieving data in response to an input query. The method involves generating, at a processor, a first query based on the input query and a second query based on the input query. The first query is for sending to a first data source and the second query is for sending to a second data source. In addition, the method involves sending the first query to the first data source via a network interface. Furthermore, the method involves receiving, in response to the first query, a first data record from the first data source. The method also involves sending the second query to the second data source via the network interface. The method further involves receiving, in response to the second query, a second data record from the second data source. Also, the method involves determining, at the processor, whether the first data record and the second data record represent a single external entity. Furthermore, the method involves combining, at the processor, the first data record and the second data record when the first data record and the second data record represent the same external entity to generate a master data record associated with the external entity. In addition, the method involves storing the master data record in a memory storage unit.

Generating the first query and the second query may involve generating the first query and the second query in parallel.

The first data source may be associated with a first service provider and the second data source may be associated with a second service provider. The first service provider may be different from the second service provider.

Generating the first query may involve generating the first query in a first query format compatible with the first service provider and generating the second query may involve generating the second query in a second query format compatible with the second service provider.

Receiving the first data record may involve receiving the first data record in a first result format from the first data source. Receiving the second data record may involve receiving the second data record in a second result format from the second data source.

The method may further involve translating the first data record from the first result format into a standard result format, and translating the second data record from the second result format into the standard result format.

Receiving the first data record may involve receiving a first plurality of data records including the first data record from the first data source. Receiving the second data record may involve receiving a second plurality of data records including the second data record from the second data source.

The method may further involve identifying the first data record from the first plurality of data records and identifying the second data record from the second plurality of data records.

The first data record and the second data record may each include overlapping information associated the single external entity.

Storing the master data record may involve caching the master data record for subsequent use.

In accordance with another aspect of the specification, there is provided a non-transitory computer readable medium encoded with codes for retrieving data in response to an input query. The codes are for directing a processor to generate a first query based on the input query and a second query based on the input query. The first query is for sending to a first data source. The second query is for sending to a second data source. The codes are also for directing a processor to send the first query to the first data source via a network interface. Furthermore, the codes are for directing a processor to receive a first data record from the first data source. In addition, the codes are for directing a processor to send the second query to the second data source via the network interface. Also, the codes are for directing a processor to receive a second data record from the second data source. The codes are also for directing a processor to determine whether the first data record and the second data record represent a single external entity. Furthermore, the codes are for directing a processor to combine the first data record and the second data record when the first data record and the second data record represent the same external entity to generate a master data record associated with the external entity. In addition, the codes are for directing a processor to store the master data record in a memory storage unit

### BRIEF DESCRIPTION OF THE DRAWINGS

Reference will now be made, by way of example only, to the accompanying drawings in which:

FIG. 1 is a schematic representation of a system for retrieving data in response to an input query in accordance with an embodiment;

FIG. 2 is a schematic representation of a data server in accordance with the embodiment shown in FIG. 1;

FIG. 3 is a schematic representation of another data server in accordance with the embodiment shown in FIG. 1;

FIG. 4 is a schematic representation of a master server in accordance with the embodiment shown in FIG. 1; and

FIG. 5 is a flow chart of a method of retrieving data in response to an input query in accordance with an embodiment.

### DETAILED DESCRIPTION OF THE EMBODIMENTS

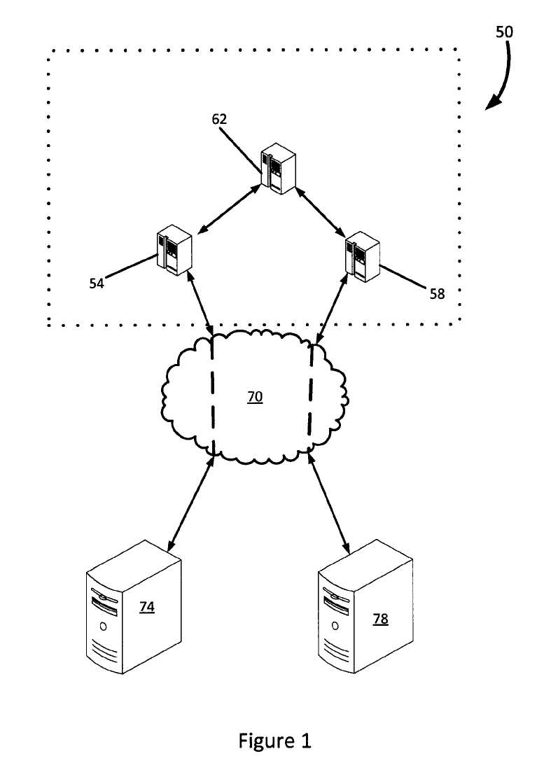

Referring to FIG. 1, a system for retrieving data in response to an input query is generally shown at 50. It is to be understood that the system 50 is purely exemplary and with the benefit of this description, it will become apparent to those skilled in the art that a variety of systems are contemplated. The system 50 includes a first data server 54, a second data server 58, and a master server 62. In the present embodiment, the first server 54 and the second server 58 are each connected directly to the master server 62 such that each of the first server 54 and the second server 58 can communicate with the master server 62 and vice versa. In other embodiments, the first server 54, the second server 58, and the master server 62 can be connected via a network 70, such as a local area network or the Internet.

In the present embodiment, the first data server 54, the second data server 58, and the master server 62 can each be any type of computing device generally used to receive input, process the input and provide output. Each of the first data server 54, the second data server 58, and the master server 62 are not particularly limited and can include a variety of different devices depending on the specific application of each of the first data server 54, the second data server 58, and the master server 62. For example, each of the first data server 54, the second data server 58, and the master server 62 can be optimized for their specific roles in the system 50. Alternatively, the first data server 54, the second data server 58, and the master server 62 can be identical devices. In further embodiments, the first data server 54, the second data server 58, and the master server 62 can be modified such that the functionality of each server is carried out in a single device, such as a multi-processor server having a processor dedicated to the functionality of each of the first data server 54, the second data server 58, and the master server 62. Suitable devices for each of the first data server 54, the second data server 58, and the master server 62 can include high performance blade server systems running UNIX operating systems having multiple processors. Alternatively, the first data server 54, the second data server 58, and the master server 62 can include devices such as a desktop personal computer configured to carry out similar functions for systems not requiring a server with significant processing power. In other embodiments, the first data server 54, the second data server 58, and the master server 62 can each be implemented as one or more virtual servers, a rented server session in the cloud, or any combination of the above.

In the present embodiment, each of the first data server 54 and the second data server 58 are connected to the network 70 for communicating with external data sources 74 and 78. In the present embodiment, the first data server 54 is configured to communicate with the data source 74 exclusively and the second data server 58 is configured to communicate with the data source 78 exclusively. It is to be appreciated, with the benefit of this description, that by exclusively dedicating a data server to a data source, the speed and efficiency by which data can be retrieved from the data source is enhanced. Furthermore, exclusively dedicating a data server to a data source modularizes the system to allow for independent development of each of the first data server 54 and the second data server 58. For example, each of the first data server 54 and the second data server 58 can be individually optimized for communications with the data source 74 and the data source 78, respectively.

It is to be appreciated, with the benefit of this description, that the data sources 74 and 78 are not particularly limited. Each of the data sources 74 and 78 are generally configured to return one or more data records in response to a query. In the present embodiment, the data source 74 can be associated with a first service provider and the data source 78 can be associated with a second service provider. For example, the first service provider can maintain a database of businesses and the second service provider can maintain a different database of similar businesses maintained by a competitor of the first service provider. Accordingly, it is to be appreciated that each of the service providers may offer similar information and return a similar data record to the data servers 54 and 58 upon receiving similar search queries based on the same input query. However, the data record may include slightly different information and be provided in a different format by each of the service providers.

It is to be re-emphasized that the system 50 described above is a non-limiting representation only. For example, although the present embodiment shown in FIG. 1 dedicates a single data server to a single external data source, other embodiments can include a single data server dedicated to a plurality of data sources, for example, to consolidate resources. In further embodiments, the system 50 can be modified to have a plurality of data servers dedicated to a single data source when the single data source is expected to process more requests than can be handled by a single data server. Furthermore, it is it is to be understood, with the benefit of this description, that the processes carried out on the first data server 54 and the second data server 58 can be combined and carried out by a single data server running on one or more shared processors or processor cores (not shown) or as separate processes carried out by separate processors or processor cores within the master server 62.

As another example of a variation, it is to be appreciated that the data sources 74 and 78 can also be operated by the same service provider. For example, a service provider may provide more than one data source to increase bandwidth for receiving queries. In other embodiments, the service provider may offer different levels of service dependent on a type of account subscription.

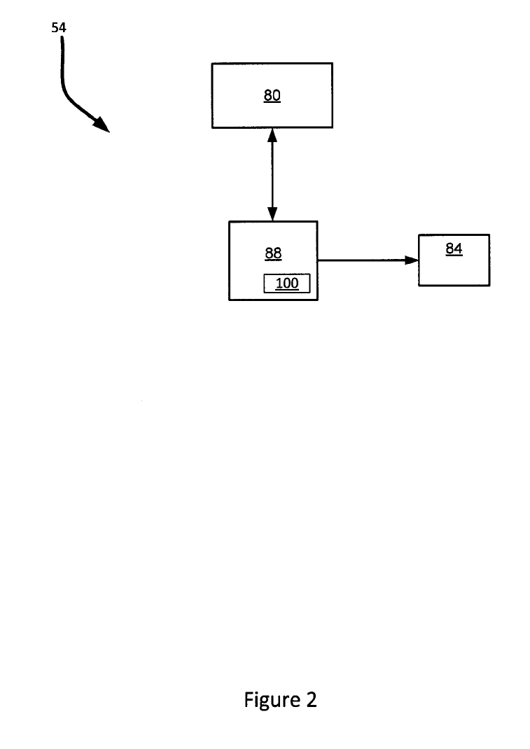

Referring to FIG. 2, a schematic block diagram showing various components of the first server 54 is provided. It should be emphasized that the structure in FIG. 2 is purely exemplary and several different implementations and configurations for the first server 54 are contemplated. In the present embodiment, the first server 54 can be any type of computing device configured to receive input, process the input and generate output. The first server 54 is not particularly limited and can be a mainframe server box or any type of computing device capable of handling the operations which are dependent on the size of the system 50. For example, the first server 54 can also be a personal computer, a personal digital assistant, a tablet computing device, cellular phone, or laptop computer, as an example. The first server 54 includes a network interface 80, and a memory storage unit 84, and a processor 88. It is to be appreciated that in other embodiments, the first server 54 can also be a virtual server in the cloud.

The network interface 80 is not particularly limited and can include various network interface devices such as a network interface controller (NIC) capable of communicating with the master server 62 and the network 70. In the present embodiment, the network interface 80 is generally configured to connect the master server 62 via a peer to peer connection and the network 70 via a standard Ethernet connection. In other embodiments, the network interface 80 can connect to the master server 62 via a network such as a wired Ethernet network, or WiFi™ network.

The memory storage unit 84 can be of any type such as non-volatile memory (e.g. Electrically Erasable Programmable Read Only Memory (EEPROM), Flash Memory, hard disk, floppy disk, optical disk, solid state drive, or tape drive) or volatile memory (e.g. random access memory (RAM)). In the present embodiment, the memory storage unit 84 is generally configured to store codes for directing the processor 88 for carrying out computer implemented methods. For example, the codes can include the programming instructions 100 further described below. In addition, the memory storage unit 84 can be configured to store data related to search queries as well as data records received in response to search queries. It is to be appreciated, with the benefit of the description, that the memory storage unit 84 can be used to store data on a permanent basis for caching purposes or on a temporary basis depending on the specific application and hardware available for the application.

The processor 88 is not particularly limited and is generally configured to execute programming instructions 100 for generating a search query based on an input query. In addition, the programming instructions 100 direct the processor 88 to send the search query to a data source 74 and further to direct the processor 88 to receive a data record from the data source 74 in response to the search query. The manner by which the processor 88 carries out the operations is not particularly limited. In the present embodiment, the processor 88 receives an input query, for example, from the master server 62 via the network interface 80. When the input query is received from the master server 62, the input query can be immediately processed or stored in the memory storage unit 84 for subsequent processing.

The programming instructions 100 cause the processor 88 to generate a search query based on the input query. In the present embodiment, the input query is generally a text string of a standard query format used by the master server 62. For example, the input query can be a text string using a proprietary format configured to be used by the master server 62 or a standard format such as an SQL query.

The programming instructions 100 subsequently cause the processor 88 to generate a search query compatible with the data source 74 and to send the generated search query to the data source 74 via the network 70. The manner by which the search query is generated is not particularly limited. For example, in some cases the search query can be identical to the input query if the data source 74 is capable of accepting the syntax of the input query received from the master server 62. In other embodiments, a syntax translation function can be used to convert the input query into a format compatible with the data source 74. The manner by which the search query is sent to the data source 74 is also not particularly limited and can involve a variety of methods used to send messages across the network 70. In the present embodiment, the search query is sent in a message to an application programming interface of the data source 74. In other embodiments, a web interface or email message can be used to send the search query.

Furthermore, the programming instructions 100 further cause the processor 88 to receive a data record from the data source 74 in response to the search query. Each data record includes information related to an external entity. For example, an external entity can be a business such as a restaurant. In this example, the data record can include information such as a menu, a place of business, a phone number, or images of the restaurant. The manner by which the data record is received is not particularly limited. For example, the processor 88 can receive the data record using involve a variety of methods including those mentioned above for sending the search query. In some embodiments, if the master server 62 can process the data record received from the data source 74, the processor 88 can pass the data record directly to the master server 62 without further processing. However, it is to be appreciated, with the benefit of the description, that if the data record received from the data source 74 is in a proprietary format that is unique to the data source 74 and that cannot be easily processed by the master server 62, the programming instructions 100 can direct the processor 88 to translate the data record from the format provided by the data source 74 into a standard result format before passing or sending the data record back to the master server 62.

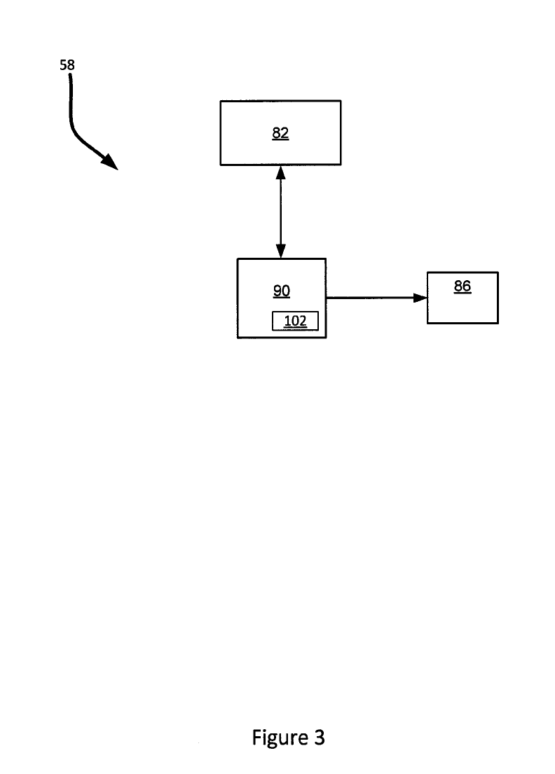

Referring to FIG. 3, a schematic block diagram showing various components of the second data server 58 is provided. Similar to the first data server 54, the second data server 58 can be any type of computing device configured to receive input, process the input and generate output. It is to be understood that the second data server 58 is not particularly limited to any machine and that several different types of computing devices are contemplated such as those contemplated for the first data server 54. The second data server 58 is configured similarly to the first data server 54 except the second data server 58 is dedicated to the data source 78. Accordingly, in the present example, the second data server 58 includes similar hardware as the first data server 54, but with programming instructions 102 optimized to for the data source 78. However, in other embodiments, the second data server 58 can be a different type of computing device capable of carrying out similar operations. In the present embodiment, the second data server 58 includes a network interface 82, a memory storage unit 86, and a processor 90.

It is to be re-emphasized that the first data server 54 and the second data server 58 described above are a non-limiting representations only. For example, it is to be appreciated, with the benefit of this description, that although the present embodiment shows two data servers, other embodiments may include several data servers. Furthermore, it is to be appreciated that in the present embodiment, the use of multiple data servers 54 and 58 provides the system 50 with the capability of accessing multiple data sources in parallel.

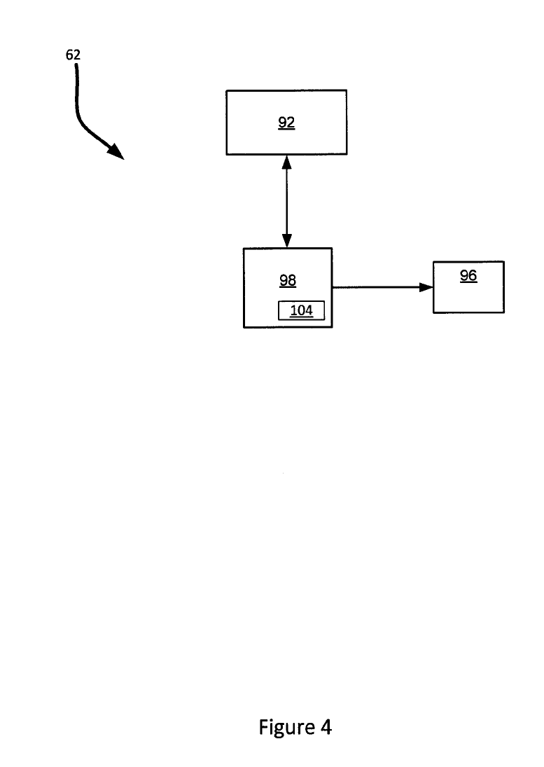

Referring to FIG. 4, a schematic block diagram showing various components of the master server 62 is provided. Similar to the first data server 54 and the second data server 58, the master server 62 can be any type of computing device configured to receive input, process the input and generate output. It is to be understood that the master server 62 is not particularly limited to any machine and that several different types of computing devices are contemplated such as those contemplated for the data servers 54 and 58. In the present embodiment, the master server 62 includes similar hardware as the data servers 54 and 58, but with programming instructions 104 configured to direct a processor 98 for operations described in greater detail below. However, in other embodiments, the master server 62 can be a different type of computing device. In the present embodiment, the master server 62 also includes a network interface 92, and a memory storage unit 96. The network interface 92 and the memory storage unit 96 are not particularly limited and can be similar to the network interface 80 and the memory storage unit 84 described above.

The processor 98 is not particularly limited and is generally configured to execute programming instructions 104 for receive data records from the data servers 54 and 58. The programming instructions 104 are also for determining whether data records represent the same external entity. For example, since the data servers 54 and 58 send queries to separate data sources 74 and 78, each of the data servers 54 and 58 can return data records corresponding to the same external entity.

In addition, the programming instructions 104 direct the processor 98 to combine data records representing the same external entity to generate a single master data record associated with the external entity. It is to be appreciated that the master data record would include an aggregate of information from data records associated with the external entity. For example, when the data records from each of the data sources 74 and 78 represent the same external entity, it is to be appreciated that the data records can include overlapping information. Continuing with the same example, the data records from both of the data sources 74 and 78 can include the phone number of the restaurant or the address of the restaurant. In addition, it is also to be appreciated that the data records from both the data sources 74 and 78 can include complimentary information associated with the external entity. Continuing with the present example, the data record from the data source 74 can include images of the interior of the restaurant, but not include a menu. In contrast, the data record from the data source 78 can include a menu, but not include images of the interior of the restaurant. The manner by which the processor 98 carries out the operations is not particularly limited. In the present embodiment, the processor 98 receives data records from each of the data servers 54 and 58 in a standard result format. The processor 98 subsequently compares predetermined fields of the data records such as the name and location and when a predetermined threshold for similarity is satisfied, the data records would be deemed to be associated with the same external entity.

The programming instructions 104 further cause the processor 98 to compare the data fields of the data records to generate the master data record. For example, where fields of the data records include identical overlapping information, the processor will include the information in the master data record. Similarly, where one data record includes no information in a field whereas another data record does include information, the processor 98 will include this information in the appropriate field of the master data record. When fields from different data records include conflicting information, the processor 98 would need to make a determination in regard to what information to include. This determination is not particularly limited and can include various options depending on the requirements of the system 50 and the conflict requirement rules. For example, some fields allow for the inclusion of multiple entries, such as an alternate address. Alternatively, the programming instructions can select the information of a data record from a predetermined preferred service provider that is known for data accuracy.

The programming instructions 104 further direct the processor 98 to store the master data record in the memory storage unit 96. It is to be appreciated, with the benefit of the description, that the manner of storing the master data record is not particularly limited. In some embodiments, the master data record is temporarily stored for returning to the client device (not shown). For example, if a service provide restricts the retention of data provided, the master data record is generally not permanently stored. In other embodiments where the service provide does not restrict the use of the information, the master data record can be cached for use in subsequent searches. In situations where some of the service providers contributing to the master data record restrict use of the information, the programming instructions 104 can be modified to cache portions of the master data record.

It is to be re-emphasized that the master server 62 described above is a non-limiting representation only. In the above example, each of the data sources 74 and 78 is described to have returned a single data record. However, the data sources 74 and 78 can also provide a plurality of data records. When each of the data sources 74 and 78 return a plurality of data records to the data servers 54 and 58, which are subsequently passed onto the master server 62, the programming instructions 104 can be modified to direct the processor 98 to identify data records corresponding to the same external entity from the two pluralities of data records.

It is to be appreciated that several variations are contemplated. For example, although only two sources are described above, other embodiments can include more sources. Furthermore, the system 50 can be modified to include more master servers, where each master server is configured to handle a specific type of input query. For example, one master server can be configured to handle queries relating to locations and another master server can be configured to handle queries relating to the phone numbers. It is to be appreciated, with the benefit of this description, that multiple master servers can be connected to each data server to retrieve information.

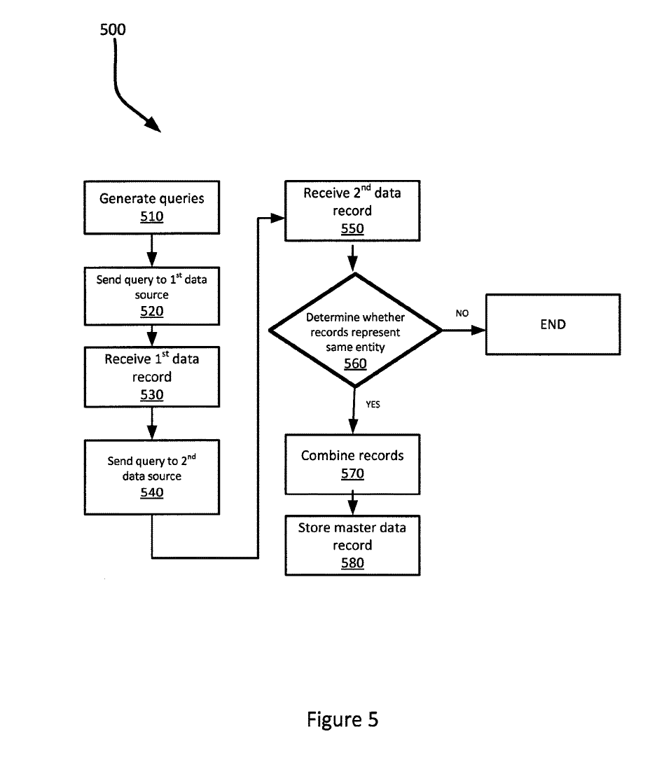

Referring now to FIG. 5, a method of retrieving data in response to an input query is represented in the form of a flow-chart and indicated generally at 500. In order to assist in the explanation of the method 500, it will be assumed that the method 500 is performed using the system 50. Furthermore, the following discussion of the method 500 will lead to further understanding of the system 50 and its various components. However, it is to be understood that the system 50 and/or the method 500 can be varied, and need not work exactly as discussed herein in conjunction with each other, and that such variations are within the scope of the present invention. Furthermore, it is to be emphasized, that method 500 need not be performed in the exact sequence as shown and that various blocks can be performed in parallel rather than in sequence; hence the elements of the method 500 are referred to herein as “blocks” rather than “steps”.

Block 510 comprises generating search queries in each of the data servers 54 and 58 based on an input query. The manner by which the queries are generated are not particularly limited and were discussed above. For example, each of the data servers 54 and 58 receive an input query corresponding to a query for which the master server 62 would like to be executed on the data sources 74 and 78. Therefore, in the present embodiment, the data servers 54 and 58 translate the syntax of the input query in to a compatible format for the data sources 74 and 78, respectively.

Blocks 520 and 540 comprise sending the search queries from the data servers 54 and 58 to the data sources 74 and 78, respectively. Blocks 530 and 550 comprise receiving the data records in response to the search queries from the data sources 74 and 78 at the data servers 54 and 58, respectively.

Block 560 comprises determining whether the data records received from the data sources 74 and 78 represent the same external entity at the master server 62. The manner by which this determination is made is not particularly limited. For example, in the present embodiment, each of the data records can be compared and if a predetermined threshold for similarity is obtained, the data records can be deemed to represent the same external entity. The manner by which the level of similarity is determined is also not particularly limited. For example, the number of identical fields in the data records can be compared.

Block 570 comprises combining the data records representing the same external entity to generate a single master data record. The manner by which this combination is performed is not particularly limited. For example, the overlapping information from the data records can be added to the master data record and complimentary information can be added as well. If there is a conflict between the data records, conflict resolution rules can be applied to determine the information that is to be entered into the master data record. It is to be appreciated, with the benefit of this specification, that by generating a single master data record in a single format, the system can retrieve information quickly and efficiently from the master data record instead of carrying out multiple searches and handling a variety of data record formats used by different service providers.

Block 580 comprises storing the master data record in the memory storage unit 96. The manner by which the master data record is stored in not limited. For example, the master data record can be temporarily stored for immediate use or cached for future use depending on the specific application of the system 50.

While specific embodiments have been described and illustrated, such embodiments should be considered illustrative only and should not serve to limit the accompanying claims.

What is claimed is:

1. A system for retrieving data in response to an input query, the system comprising:
a first data server configured to generate a first query based on the input query, the first data server further configured to send the first query to a first data source and to receive a first data record from the first data source;
a second data server configured to generate a second query based on the input query, the second data server further configured to send the second query to a second data source and to receive a second data record from the second data source; and
a master server in communication with the first data server and the second data server, the master server configured to determine whether the first data record and the second data record represent a single external entity and to combine the first data record and the second data record when the first data record and the second data record represent the same external entity to generate a master data record associated with the external entity, the master server further configured to store the master data record in a memory storage unit.

2. The system of claim 1, wherein the first data server and the second data server are configured to operate in parallel.

3. The system of claim 1 or 2, wherein the first data source is associated with a first service provider and the second data source is associated with a second service provider, the first service provider different from the second service provider.

4. The system of claim 3, wherein the first data server is configured to generate the first query in a first query format compatible with the first service provider and the second data server is configured to generate the second query in a second query format compatible with the second service provider.

5. The system of claim 3, wherein the first data server is configured to receive the first data record in a first result format from the first service provider and the second data server is configured to receive the second data record in a second result format from the second data source.

6. The system of claim 5, wherein the first data server is configured to translate the first result format into a standard result format, and the second data server is configured to translate the second result format into the standard result format.

7. The system of any one of claims 1 to 6, wherein the first data server is configured to receive a first plurality of data records including the first data record from the first data source and the second data server is configured to receive a second plurality of data records including the second data record from the second data source.

8. The system of claim 7, wherein the master server is configured to identify the first data record from the first plurality of data records and to identify the second data record from the second plurality of data records.

9. The system of claim 8, wherein the first data record and the second data record each include overlapping information associated the single external entity.

10. The system of claim 9, wherein the first data record and the second data record each include complimentary information associated the single external entity.

11. The system of any one of claims 1 to 10, wherein the master server is configured to cache the master data record for subsequent use.

12. A method of retrieving data in response to an input query, the method comprising:
generating, at a processor, a first query based on the input query and a second query based on the input query, the first query for sending to a first data source and the second query for sending to a second data source;
sending the first query to the first data source via a network interface;
receiving, in response to the first query, a first data record from the first data source;
sending the second query to the second data source via the network interface;
receiving, in response to the second query, a second data record from the second data source;
determining, at the processor, whether the first data record and the second data record represent a single external entity;
combining, at the processor, the first data record and the second data record when the first data record and the second data record represent the same external entity to generate a master data record associated with the external entity; and
storing the master data record in a memory storage unit.

13. The method of claim 12, wherein generating the first query and the second query comprises generating the first query and the second query in parallel.

14. The method of claim 12 or 13, wherein the first data source is associated with a first service provider and the second data source is associated with a second service provider, the first service provider different from the second service provider.

15. The method of claim 14, wherein generating the first query comprises generating the first query in a first query format compatible with the first service provider and generating the second query comprises generating the second query in a second query format compatible with the second service provider.

16. The method of claim 14, wherein receiving the first data record comprises receiving the first data record in a first result format from the first data source and receiving the second data record comprises receiving the second data record in a second result format from the second data source.

17. The method of claim 16, further comprising translating the first data record from the first result format into a standard result format, and translating the second data record from the second result format into the standard result format.

18. The method of any one of claims 12 to 17, wherein receiving the first data record comprises receiving a first plurality of data records including the first data record from the first data source and receiving the second data record comprises receiving a second plurality of data records including the second data record from the second data source.

19. The method of claim 18, further comprising identifying the first data record from the first plurality of data records and identifying the second data record from the second plurality of data records.

20. The method of claim 19, wherein the first data record and the second data record each include overlapping information associated the single external entity.

21. The method of claim 20, wherein the first data record and the second data record each include complimentary information associated the single external entity.

22. The method of any one of claims 12 to 21, wherein storing the master data record comprises caching the master data record for subsequent use.

23. A non-transitory computer readable medium encoded with codes for retrieving data in response to an input query, the codes for directing a processor to:
generate a first query based on the input query and a second query based on the input query, the first query for sending to a first data source and the second query for sending to a second data source;
send the first query to the first data source via a network interface;
receive a first data record from the first data source;
send the second query to the second data source via the network interface;
receive a second data record from the second data source;
determine whether the first data record and the second data record represent a single external entity;
combine the first data record and the second data record when the first data record and the second data record represent the same external entity to generate a master data record associated with the external entity; and
store the master data record in a memory storage unit.
